(19) United States
(12) Patent Application Publication
(10) Pub. No.: US 2011/0015824 A1
(43) Pub. Date: Jan. 20, 2011

(54) METHOD FOR THE ON-BOARD FUNCTIONAL DIAGNOSIS OF A SOOT SENSOR IN A MOTOR VEHICLE AND/OR FOR THE DETECTION OF FURTHER CONSTITUENTS IN THE SOOT

(75) Inventors: Johannes Ante, Regensburg (DE); Rudolf Bierl, Regensburg (DE); Markus Herrmann, Regensburg (DE); Andreas Ott, Steinsberg (DE); Willibald Reitmeier, Hohenschambach (DE); Denny Schaedlich, Neustadt (DE); Manfred Weigl, Viehhausen (DE); Andreas Wildgen, Nittendorf (DE)

Correspondence Address: COHEN, PONTANI, LIEBERMAN & PAVANE LLP, 551 FIFTH AVENUE, SUITE 1210, NEW YORK, NY, 10176, US

(73) Assignee: Continental Automotive GmbH, Hannover (DE)

(21) Appl. No.: 12/836,076

(22) Filed: Jul. 14, 2010

(30) Foreign Application Priority Data
Jul. 14, 2009 (DE) 10 2009 033 232.4

(51) Int. Cl. G01M 15/00

(52) U.S. Cl. 701/34

(57) ABSTRACT

A method for the on-board functional diagnosis of a soot sensor and detection of further constituents in the soot in a motor vehicle having an internal combustion engine. The soot sensor is connected electrically to an evaluation circuit in the motor vehicle. A faulty soot sensor and/or further constituents in the soot can be detected in an inexpensive way. The evaluation circuit measures the voltage coefficient of the soot sensor and detects the defectiveness of the soot sensor and/or the presence of further constituents in the soot using the voltage coefficient of the soot sensor.

### BACKGROUND OF THE INVENTION

1. Field of the Invention

The invention relates to a method for the on-board functional diagnosis of a soot sensor in a motor vehicle, the detection of further constituents in the soot, a soot sensor operated according to this method, and an evaluation circuit which is installed fixedly in a motor vehicle with an internal combustion engine for the on-board functional diagnosis of a soot sensor.

2. Description of the Related Art

The accumulation in the atmosphere of pollutants from exhaust gases is currently being described a lot. Associated with this is the fact that the availability of fossil energy sources is limited. As a reaction to this combustion processes in internal combustion engines are optimized thermodynamically, with the result that their efficiency is improved. In the automotive field, this results in the increasing use of diesel engines. However, in comparison with optimized gasoline engines, the disadvantage of this combustion technology is a considerably increased emission of soot. The soot is very carcinogenic, in particular as a result of the accumulation of polycyclic aromatics, which has already been reacted to in various directives. For example, exhaust gas emission standards with maximum limits for the soot emissions have been issued. There is therefore the necessity to specify inexpensive sensors which reliably measure the soot content in the exhaust gas flow of motor vehicles.

The use of soot sensors of this type serves to measure the currently emitted soot, in order that the engine management system in an automobile is given information in a current driving situation, to reduce the emission values by way of adaptations using regulation technology. Moreover, active exhaust gas purification by exhaust gas soot filters can be initiated with the aid of the soot sensors, or exhaust gas recirculation to the internal combustion engine can take place. In the case of soot filtering, regenerable filters are used which filter a substantial part of the soot content out of the exhaust gas. Soot sensors are required for the detection of soot, to monitor the function of the soot filters and/or to control their regeneration cycles.

To this end, a soot sensor can be connected in front of and/or behind the soot filter, which is also called a diesel particulate filter.

The sensor connected in front of the diesel particulate filter increases the system reliability and to ensures operation of the diesel particulate filter under optimum conditions. Since this depends to a great extent on the soot quantity accumulated in the diesel particulate filter, precise measurement of the particulate concentration in front of the diesel particulate filter system, in particular the determination of a high particulate concentration in front of the diesel particulate filter, is of great significance.

A sensor connected behind the diesel particulate filter affords the possibility to perform an on-board diagnosis and serves to ensure correct operation of the exhaust gas aftertreatment system.

There have been various approaches to the detection of soot in the prior art. One approach that has been used in laboratories comprises the use of light scattering by the soot particles. This procedure is suitable for complicated measuring units. If an attempt is also made to use this as a mobile sensor system in the exhaust gas, it has to be determined that approaches for realizing an optical sensor in a motor vehicle are associated with high costs. Furthermore, there are unsolved problems with regard to the contamination of the required optical windows by combustion exhaust gases.

German laid-open specification DE 199 59 871 A1 discloses a sensor and operating method for the sensor, both being based on thermal considerations. The sensor comprises an open porous shaped body, for example of a honeycomb ceramic, a heating element and a temperature sensor. If the sensor is brought into contact with a measuring gas volume, soot is deposited on it. For measurement, the soot that is deposited in a time period is ignited and burnt with the aid of the heating element. The temperature increase which is produced during the burning is measured.

Particulate sensors for conductive particulates are currently known, in which two or more metallic electrodes are provided which have electrodes that engage into one another in a comb-like manner. Soot particles which are deposited on these sensor structures short-circuit the electrodes and therefore change the impedance of the electrode structure. As the particulate concentration on the sensor face rises, in this way a reducing resistance or an increasing current can be measured with a constant applied voltage between the electrodes. A soot sensor of this type is disclosed in DE 10 2004 028 997 A1.

The comb-like electrode structure of said soot sensors is formed from thin conductor tracks that lie next to one another. The conductor tracks are at a spacing of 10 μm from one another. In addition to the desired resistance change of the soot sensor as a result of soot loading of the comb structure, the resistance of the soot sensor can also be changed by undesired short circuits. Said undesired short circuits can be caused, for example, by a scratched or partially detached electrode. The measured resistance value of the soot sensor would be falsified by said undesired short circuits, which can be determined only by a regular functional diagnosis of the soot sensor.

### SUMMARY OF THE INVENTION

It is therefore the object of the invention to specify a method for the functional diagnosis of a soot sensor and/or for the detection of further constituents in the soot, by way of which method a faulty soot sensor and/or further constituents in the soot can be detected in an inexpensive way.

Regular monitoring of the soot sensor is possible because the soot sensor is connected electrically to an evaluation circuit, which is installed fixedly in the motor vehicle, the evaluation circuit measuring the voltage coefficient of the soot sensor and detecting the defectiveness of the soot sensor using the voltage coefficient. To monitor the soot sensor, the motor vehicle does not have to be brought to a specialist workshop, and the function of the soot sensor can be monitored almost without interruptions. Moreover, further constituents of the soot can also be detected using the voltage coefficient of the soot sensor. If, for example, there are water, hydrocarbons, engine oil and/or an ash proportion from burnt additives in the soot, this will result in a characteristic change in the voltage coefficient of the soot sensor. The presence of constituents of this type in the soot can therefore be detected with the aid of the voltage coefficient of the soot sensor.

In one embodiment of the invention, the evaluation circuit detects the defectiveness of the soot sensor and/or the presence of further constituents in the soot if a lower voltage coefficient is measured by the evaluation circuit than that of a fault-free soot sensor. Since the measuring electrodes of the soot sensor form a comb structure with very small electrode spacings (for example, 10 μm), very high electric field strengths are achieved between the measuring electrodes and the soot particles which are deposited on the latter, even if there is only a relatively low voltage on the soot sensor itself. An applied voltage of 1 V on the soot sensor results, for example, in an electric field strength of 100 V/mm between the individual measuring electrodes. However, this also results in a high voltage dependence of the resistance value of the soot sensor. If the soot sensor is intact and operates without faults, the resistance which is measured at the soot sensor is influenced by the soot layer on the measuring electrodes of the soot sensor. The measured resistance has a very high dependence on the measuring voltage, and an intact and fault-free soot sensor exhibits a high voltage coefficient. If, however, there is a short circuit in the electrode structure and therefore a faulty soot sensor, the resistance value of the soot sensor can certainly lie in the usual measuring range on account of the fine comb structure of the sensor electrodes. Since, however, this resistance is formed substantially by the long comb structure of the metallic measuring electrodes (usually platinum) of the soot sensor, there will be only a very low voltage dependence of the resistance value and therefore a low voltage coefficient. A distinction between a faulty and a fault-free soot sensor is therefore possible without problems if a lower voltage coefficient is measured by the evaluation circuit than that of a fault-free soot sensor.

In one embodiment of the invention, the voltage coefficient of the fault-free soot sensor is stored in an electronic memory of the evaluation circuit. Electronic memories of this type can be produced very easily on an integrated circuit. In the case of a first start up of a new and therefore fault-free soot sensor, the evaluation circuit can determine the voltage coefficient of the fault-free soot sensor and store it in the memory. As an alternative, the voltage coefficient of the fault-free soot sensor can be determined outside the vehicle before the installation of the soot sensor and can be written from the outside into the electronic memory which is integrated into the evaluation circuit.

If the voltage coefficient of the soot sensor is measured when the internal combustion engine is switched off, the measured result does not contain any corruptions as a result of soot particles which are newly deposited during the measurement.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the following text, the present invention will be explained using one preferred embodiment with reference to the accompanying drawings. This embodiment comprises a soot sensor for use in a motor vehicle. In the drawings:

FIG. 1 is a soot sensor;

FIG. 2 depicts the soot sensor in operation;

FIG. 3 is an evaluation circuit which is installed fixedly in a motor vehicle for the on-board functional diagnosis of the soot sensor; and

FIG. 4 is a motor vehicle with an internal combustion engine.

### DETAILED DESCRIPTION OF THE PRESENTLY PREFERRED EMBODIMENTS

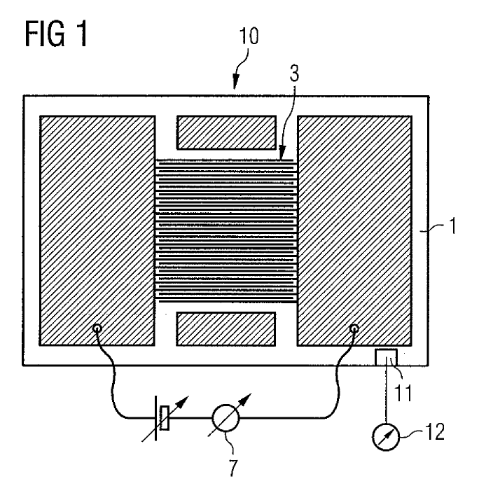

FIG. 1 is a soot sensor 10 constructed from a shaped body 1, a heating element and a structure comprising measuring electrodes 3. The shaped body 1 can be produced from a ceramic material or from another material which has electrically insulating properties and withstands a burn-off temperature of soot without problems. In order to burn the soot sensor 10 free of soot, the soot sensor 10 is typically heated to temperatures between 500 and 800° C. with the aid of an electric resistance heater. The electrically insulating shaped body 1 has to withstand these temperatures without damage. Here, the structure of the measuring electrodes 3 is configured as a comb-like structure; an electrically insulating region of the shaped body 1 can be seen between two measuring electrodes. The current flow from a current a voltage source between the electrode structures is measured with the aid of a current measuring element 7. As long as the soot sensor 10 is completely free of soot particles 4, no direct current will be capable of being measured by the current measuring element 7, since there is always a region of the shaped body 1 between the measuring electrodes 3, which region has an electrically insulating effect and is not bridged by soot particles 4. Furthermore, FIG. 1 shows a temperature sensor 11 as a constituent part of the soot sensor 10 with temperature evaluation electronics 12 which serve to monitor the temperature prevailing in the soot sensor 10, at least while the soot loading on the soot sensor 10 is being burnt off.

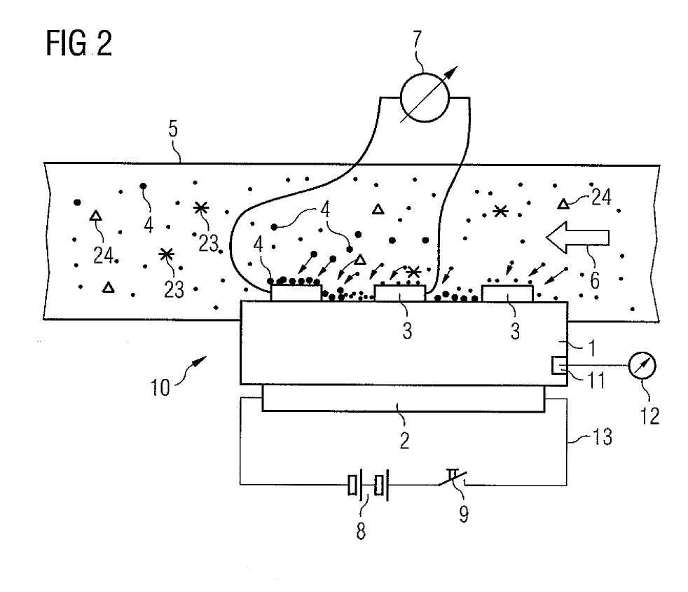

FIG. 2 shows the operation of the soot sensor 10. Here, the soot sensor 10 is arranged in an exhaust gas pipe 5, through which an exhaust gas flow 6, which is loaded with the soot particles 4, is guided. In addition to the soot particles 4, the exhaust gas flow 6 can also contain further constituents such as water 23, hydrocarbons 24, engine oil and/or ash proportions from burnt additives. The flow direction of the exhaust gas flow 6 is indicated by the arrow 6. It is an object of the soot sensor 10 to measure the concentration of the soot particles 4 in the exhaust gas flow 6. To this end, the soot sensor 10 is arranged in the exhaust gas pipe 5 in such a way that the structure of measuring electrodes 3 is introduced into or faces the exhaust gas flow 6 and therefore the soot particles 4. From the exhaust gas flow 6, soot particles 4 are deposited both on the measuring electrodes 3 and also in the interspaces between the measuring electrodes 3 on the insulating regions of the shaped body 1. If sufficient soot particles 4 have been deposited on the insulating regions between the measuring electrodes 3, a direct current will flow between the measuring electrodes 3 on account of the conductivity of the soot particles 4, which direct current can be detected by the current measuring element 7. The soot particles therefore bridge the electrically insulating interspaces between the measuring electrodes 3. In this way, the loading of the exhaust gas flow 6 with soot particles 4 can be measured by way of the soot sensor 10 which is depicted here.

In addition, the soot sensor 10 in FIG. 2 depicts the heating element 2 which can be supplied with electric current from the heating current supply 8 by way of the heating current circuit 13. In order to heat the soot sensor 10 to the burn-off temperature of the soot particles 4, the heating current switch 9 is closed, whereby the heating element 2 is heated and therefore the entire soot sensor 10 is heated. Moreover, a temperature sensor 11 is integrated into the soot sensor 10, which temperature sensor 11 monitors the operation of heating of the soot sensor 10 and therefore the burn-off operation of the soot particles 4 with the aid of the temperature evaluation electronics 12.

Here, the current measuring element 7, the temperature evaluation electronics 12 and the heating current switch 9 are shown by way of example as discrete components; it goes without saying that these components can be a constituent part of a microelectronic circuit which is integrated into a control unit for the soot sensor 10.

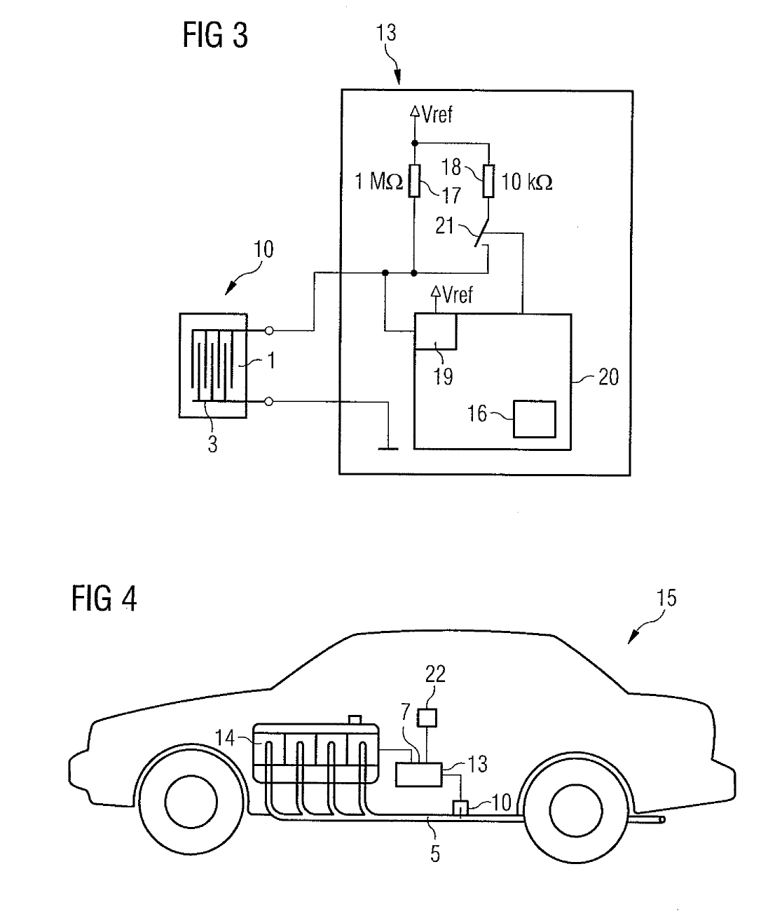

FIG. 3 is evaluation circuit 13 installed fixedly in a motor vehicle 15 for the on-board functional diagnosis of the soot sensor 10 and/or for the detection of further constituents in the soot. Here, the soot sensor 10 is connected electrically to the evaluation circuit 13. The soot sensor 10 therefore becomes part of a voltage divider network with the first electric resistance 17 and, when the C-MOS switch 21 is switched on, also with the second electric resistance 18. The measuring electrodes 3 can be seen on the shaped body 1 of the soot sensor 10. In the evaluation circuit 13, two resistances 17, 18 with resistance values of different magnitude are connected in parallel and are connected to a reference voltage V_{ref}. The first resistance 17 selected here has, for example, the resistance value 1 MΩ and the second resistance 18 has, for example, the resistance value 10 kΩ. The resistance values of the two resistances 17, 18 are therefore clearly different from one another by orders of magnitude. The first electric resistance 17 with the resistance value 1 MΩ selected by way of example here and the soot sensor 10 together form a voltage divider, it being possible for the voltage which drops at the soot sensor 10 to be measured by the microcontroller 20. After a voltage measurement via the voltage divider from the first electric resistance 17 and the soot sensor 10, a second electric resistance 18 can be connected in parallel to the first electric resistance 17 with the aid of the switch 21 which can be configured as an electronic C-MOS switch on an integrated circuit. A voltage then drops from the reference voltage V_{ref} via the parallel circuit comprising the first electric resistance 17 and the substantially smaller second electrical resistance 18, the parallel combination of the first electric resistance 17 and the second electric resistance 18 and the following soot sensor 10 in turn forming a voltage divider. A different voltage is then set at the soot sensor 10 than in the case of the voltage divider which is formed only between the first resistance 17 and the soot sensor 10. The voltage that drops across the soot sensor 10 can then be measured in turn by the microcontroller 20, and its resistance can be determined. The voltage coefficient of the soot sensor 10 can be determined with these two resistance values of the soot sensor 10. The voltage coefficient (VC) of a resistance specifies the change in the resistance value of the resistance as a function of the applied voltage and has the unit ppm/V. The voltage coefficient is also called a coefficient of voltage of a resistance. This voltage coefficient is very small and negative for many resistance materials, which results in resistance values which become smaller in the case of an increase in the applied voltages. In the case of the intact soot sensor 10, however, the voltage coefficient is relatively high because the resistance value of the intact soot sensor 10 is derived from the high electric field strength between the measuring electrodes 3. It is to be noted that the detection of the fault-free nature of the soot sensor 10 with the aid of its voltage coefficient is attributed substantially to the effects of the dependence of the resistance value of the soot sensor 10 on the sensor voltage, which effects are dominated by the electric field strength between the intact measuring electrodes 3.

An electronic memory 16, in which the voltage coefficient of a fault-free soot sensor 10 is stored, is provided in the evaluation circuit 13 on the microcontroller 20. The measured voltage coefficient of the soot sensor 10 can then be compared with the voltage coefficient of a fault-free soot sensor 10, which voltage coefficient is stored in the electronic memory 16. If the voltage coefficient of the soot sensor 10 which is measured by the evaluation circuit 13 is substantially smaller than that of a fault-free soot sensor 10, the evaluation circuit 13 detects the defectiveness of the soot sensor 10. A corresponding fault signal can then be sent to an engine management system in the motor vehicle, the driver of the motor vehicle being requested to replace the soot sensor 10 and the fault being stored in the on-board diagnosis unit of the motor vehicle.

For the general illustration of the entire system, FIG. 4 shows a motor vehicle 15 with an internal combustion engine 14. The internal combustion engine 14 discharges the exhaust gas flow 6 which is produced by it via an exhaust gas pipe 5. A soot sensor 10 is arranged in the exhaust gas pipe 5, which soot sensor 10 is connected to an evaluation circuit 13 which can also contain the current measuring element 7. The evaluation circuit 13 which is described in detail under FIG. 3 forwards the signals relating to the defectiveness of the soot sensor 10 and/or the findings about further constituents in the soot to the on-board diagnosis unit 22. Both the current measuring element 7 for measuring the soot loading of the exhaust gas flow 6 and the evaluation circuit 13 for the on-board functional diagnosis of a soot sensor 10 in a motor vehicle 15 can be configured on one and the same integrated electronic circuit.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A method for on-vehicle for at least one of functional diagnosis of a soot sensor and for detecting further components in the exhaust of an internal combustion engine, the soot sensor electrically connected to an evaluation circuit, the method comprising:
measuring a voltage coefficient of the soot sensor; and
detecting based at least in part on the voltage coefficient at least one of:
a defectiveness of the soot sensor and the presence of further components in the soot.

2. The method as claimed in claim 1, further comprising:
comparing the voltage coefficient measured by the evaluation circuit to a voltage coefficient of a fault-free soot sensor,
wherein the evaluation circuit detects the at least one of the defectiveness of the soot sensor and the presence of further components in the soot if the voltage coefficient measured by the evaluation circuit is lower than the voltage coefficient of a fault-free soot sensor.

3. The method as claimed in claim 2, wherein the voltage coefficient of the fault-free soot sensor is stored in an electronic memory of the evaluation circuit.

4. The method as claimed in claim 1, wherein the voltage coefficient of the soot sensor is measured with the internal combustion engine switched off.

5. A soot sensor comprising:
a structure comprising measurement electrodes configured as a comb-type electrode structure;
an evaluation circuit electrically connected to at least the electrode structure, the evaluation configured to:
measure a voltage coefficient of the soot sensor; and
detect based at least in part on the voltage coefficient at least one of:
a defectiveness of the soot sensor and the presence of further components in the soot.

6. An evaluation circuit permanently installed in a motor vehicle having an internal combustion engine and intended for at least one of on-vehicle functional diagnosis of a soot sensor and for detecting further components in the soot, the soot sensor being connected electrically to the evaluation circuit, wherein the evaluation circuit is configured to:
measure a voltage coefficient of the soot sensor; and
detect from the voltage coefficient at least one of:
a defectiveness of the soot sensor and further components in the soot.

7. The evaluation circuit as claimed in claim 6, configured to compare the voltage coefficient measured by the evaluation circuit to a voltage coefficient of a fault-free soot sensor,
wherein the evaluation circuit detects the at least one of the faultiness of the soot sensor and the presence of further components in the soot if the voltage coefficient measured by the evaluation circuit is lower than the voltage coefficient fault-free soot sensor.

8. The evaluation circuit as claimed in claim 7, wherein the voltage coefficient of the fault-free soot sensor is stored in an electronic memory of the evaluation circuit.

9. The evaluation circuit as claimed in claim 6, wherein the voltage coefficient of the soot sensor is measured with the internal combustion engine switched off.

10. The method as claimed in claim 1, wherein the evaluation circuit is permanently installed in the motor vehicle.

11. The evaluation circuit as claimed in claim 6, further comprising:
a reference voltage source;
a first resistor coupled between the voltage source and the soot sensor; and
a second resistor coupled to the voltage source;
a CMOS switch configured to electrically connect the second resistor to the soot sensor in parallel to the first resistor,
wherein the first resistor and the soot sensor form a voltage divider.

12. The evaluation circuit as claimed in claim 11, further comprising: a microprocessor configured to control the CMOS switch.

13. The evaluation circuit as claimed in claim 12, wherein the first resistor has a resistance that is larger than the second resistor.

14. The evaluation circuit as claimed in claim 13, wherein the first resistor is about 1 M′Ω and the second resistor is about 10 k′Ω.
